(19) United States
(12) Patent Application Publication
(10) Pub. No.: US 2023/0377396 A1
(43) Pub. Date: Nov. 23, 2023

(54) VENUE ENTRY SYSTEM AND METHOD

(71) Applicant: Ginter Electrical Contractors, LLC., Erlanger, KY (US)

(72) Inventor: Thomas J. Dooley, III, Newport, KY (US)

(21) Appl. No.: 18/247,002

(22) PCT Filed: Sep. 29, 2021
(86) PCT No.: PCT/US2021/052603

§ 371 Date: Mar. 28, 2023

Related U.S. Application Data
(60) Provisional application No. 63/223,327, filed on Jul. 19, 2021.
(60) Provisional application No. 63/222,870, filed on Jul. 16, 2021.
(60) Provisional application No. 63/209,280, filed on Jun. 10, 2021.
(60) Provisional application No. 63/085,143, filed on Sep. 29, 2020.

(51) Int. Cl. G07C 9/15; G07C 9/22; G06V 20/52

(52) U.S. Cl. CPC G07C 9/15; G07C 9/22; G06V 20/52

(57) ABSTRACT

A mobile security system used to manage pedestrian activities from a perimeter of a venue to a point of entry to the venue and into the venue. The mobile security system includes a portable hub unit configured to be located at the point of entry to the venue. The hub unit includes at least one touchless screening lane that defines a path through the hub unit. The hub unit also includes at least one external screening device that screens for security threats external to the hub unit, and a plurality of lane screening devices associated with the at least one screening lane to screen for security threats within the at least one screening lane. The hub unit further includes a processing unit configured to receive data and characterize the received data as being indicative of one or more security threats or a non-security threat.

### CROSS-REFERENCE TO RELATED APPLICATION

This application claims the benefit of U.S. Provisional Application Ser. No. 63/085,143 filed on Sep. 29, 2020, U.S. Provisional Application Ser. No. 63/209,280 filed on Jun. 10, 2021, U.S. Provisional Application Ser. No. 63/222,870 filed on Jul. 16, 2021, and U.S. Provisional Application Ser. No. 63/223,327 filed on Jul. 19, 2021. The disclosure of each of the above-listed Provisional Applications is hereby incorporated by reference in its entirety.

### TECHNICAL FIELD

This invention relates generally to crowd management and venue security and, more particularly, to a mobile security system that provides for crowd management and security at a point of entry to a venue.

### BACKGROUND

Venues, by their very nature, serve to gather people. Whether it be a concert, conference, or sporting event, inviting as they may be, every venue around the world is vulnerable to significant damage to both people and property. This damage can stem from physical harm inflicted by traditional mechanical weapons, to explosive, chemical, and biological hazards—in manners that are intentional (e.g., premeditated mass-casualty event) or inadvertent (e.g., an unsuspecting carrier of a transmittable virus). Unfortunately, with larger venues driving larger crowds, a greater potential and likelihood for damage exists while making more difficult the efforts to effectively secure the venue and manage crowds.

Past efforts directed to venue security and crowd management strategies include utilizing large numbers of security personnel for invasive screening of persons and their belongings before entering the venue. This typically includes piecemeal deployments of individual and narrowly focused screening devices (e.g., metal detector, gun sniffing device). Furthermore, these traditional efforts tend to be either (1) placed at or in the venue entrance, which brings potential dangers to the door of the venue, (2) displaced from the venue entrance with a tradeoff of screening limitations due to the ineffectiveness of bringing indoor-designed equipment outside, or (3) cost prohibitive to deploy every screening device needed to mitigate the dangers.

Furthermore, the traditional efforts discussed above detract from the venue experience desired by venue attendees. In this regard, the more secure a venue is attempted to be made, the more inconvenient and invasive the screening process tends to be, leading to an increase in the general stress and anxiety-inducing nature of the security screening process. This inconvenience is only amplified with larger crowds.

Accordingly, there is a need for a portable, less intrusive crowd management and venue security screening solution that mitigates the invasiveness of traditional security screening equipment, while also addressing the limitations of traditional efforts in maintaining a positive venue attendee experience.

### SUMMARY

The present invention overcomes the foregoing and other shortcomings and drawbacks of venue security devices. While the present invention will be discussed in connection with certain embodiments, it will be understood that the present invention is not limited to the specific embodiments described herein.

According to one embodiment of the invention, a mobile security system for managing pedestrian activities from a perimeter of a venue to a point of entry to the venue as well as pedestrian entry into the venue is provided. The security system includes a portable hub unit having a first end wall and a second end wall between which a top wall, a bottom wall, a front wall, and a back wall extend to define an interior of the hub unit. The hub unit is configured to be located at the point of entry to the venue such that the front wall faces an unsecured area outside the venue and the back wall faces a secured area inside the venue. The hub unit further includes at least one touchless screening lane that extends from an entrance to the at least one screening lane in the front wall of the hub unit to an exit in the back wall of the hub unit such that the at least one screening lane defines a path through the hub unit from the unsecured area outside of the venue to the secured area inside the venue. The hub unit also includes at least one external screening device located on the hub unit that screens for security threats external to the hub unit and a plurality of lane screening devices associated with the at least one screening lane to screen for security threats within the at least one screening lane. The hub unit includes a processing unit with one or more processors having program code that, when executed by the one or more processors, causes the one or more processors to receive data from the at least one external screening device and the plurality of lane screening devices, characterize the received data as being indicative of one or more security threats or a non-security threat, and in response to determining that the received data is indicative of one or more security threats, output a notification that identifies the one or more security threats.

According to an aspect of the invention, the hub unit further includes a control room located within the interior of the hub unit. The control room is an enclosed space separate from the at least one screening lane and has an access door located in the back wall of the hub unit.

According to another aspect of the invention, the at least one external screening device monitors for security threats between the hub unit and the perimeter of the venue. According to one aspect of the invention, each of the plurality of lane screening devices and the at least one external screening device screen for security threats in a touchless manner. In another aspect of the invention, the plurality of lane screening devices associated with the at least one screening lane include a combination of the following: a video camera, a thermal sensor, a pair of magnetic radar posts, a biohazard detection device, a radiation detection device, and an x-ray detection device. In another aspect, at least one external screening device further comprises a video camera.

In another aspect of the invention, the data received from the plurality of lane screening devices and the at least one external screening device is characterized as being indicative of one or more of the following security threats: (i) a concealed weapon threat, (ii) an exposed weapon threat, (iii) a bomb threat, (iv) a biohazard threat, (v) a radiation threat, (vi) a personal protective equipment non-compliance threat, (vii) an elevated body temperature threat, and (viii) a crowd disturbance threat.

In another aspect of the invention, the at least one screening lane further includes a touchless ticket scanning device configured to scan a ticket to determine pedestrian admittance into the venue.

In another aspect of the invention, the processing unit is programmed to send the alert to one or more computing devices in a network.

In yet another aspect of the invention, the hub unit includes at least one illuminated display device pivotably coupled to one of either the first end wall, the second end wall, or top wall. In one aspect, the at least one illuminated display device is movable between an extended position where the illuminated display device extends away from the one of either the first end wall, the second end wall, or top wall and a stowed position where the illuminated display device extends alongside the one of either the first end wall, the second end wall, or top wall.

In another aspect, the first end wall includes a first illuminated display device and the second end wall includes a second illuminated display device. In a further aspect of the invention, the first end wall and the second end wall each include a recessed portion configured to receive the corresponding first illuminated display device and second illuminated display device therein when in the stowed position. In yet another aspect, the top wall includes a third illuminated display device and a fourth illuminated display device.

In another aspect of the invention, the hub unit further comprises one or more solar panels located on the top wall of the hub unit and being configured to generate electricity to power components of the hub unit. In a further aspect of the invention, the one or more solar panels are configured to provide power via ethernet cabling to the at least one external screening device and the plurality of lane screening devices. In another aspect, the ethernet cabling is routed through shielded wireways.

In another aspect of the invention, the front wall of the hub unit further includes a display device located above the entrance to the at least one screening lane that is configured to display a screening status of the at least one screening lane. In yet another aspect, the back wall of the hub unit further includes a display device located above the exit to the at least one screening lane that is configured to display a screening status of the at least one screening lane. According to a further aspect, the processing unit is programmed to operate each display device as follows: if received data from one or more of the plurality of lane screening devices associated with the at least one screening lane is characterized as being indicative of one or more security threats, change the screening status of each display device to indicate a detected security condition.

In another aspect of the invention, the security system includes at least one perimeter unit configured to be located a distance from the hub unit and within the unsecured area outside of the venue. The perimeter unit includes at least one perimeter screening device to screen for security threats. The processing unit is programmed to receive data from the at least one perimeter screening device.

According to another embodiment of the invention, a portable hub unit for managing pedestrian activities from a perimeter of a venue to a point of entry to the venue as well as pedestrian entry into the venue is provided. The hub unit includes a first end wall and a second end wall between which a top wall, a bottom wall, a front wall, and a back wall extend to define an interior of the hub unit. The hub unit further includes at least one screening lane that extends from an entrance to the at least one screening lane in the front wall of the hub unit to an exit in the back wall of the hub unit. The hub unit includes at least one external screening device located on the hub unit that screens for security threats external to the hub unit and a plurality of lane screening devices associated with the at least one screening lane that screen for security threats within the at least one screening lane. The hub unit includes a processing unit with one or more processors having program code that, when executed by the one or more processors, causes the one or more processors to receive data from the at least one external screening device and the plurality of lane screening devices, characterize the received data as being indicative of one or more security threats or a non-security condition, and in response to determining that the received data is indicative of one or more security threats, output a notification that identifies the one or more security threats. The hub unit of this embodiment is configured to be located at the point of entry to the venue such that the front wall faces an unsecured area outside the venue and the back wall faces a secured area inside the venue such that the at least one screening lane defines a path through the hub unit from the unsecured area outside of the venue to the secured area inside the venue.

In another embodiment of the invention, a method for managing pedestrian entry into a venue is provided. The method includes providing a portable hub unit having at least one screening lane that extends from an entrance to the at least one screening lane in a front side of the hub unit to an exit in a back side of the hub unit, at least one external screening device located on the hub unit that screens for security threats external to the hub unit, a plurality of lane screening devices associated with the at least one screening lane that screen for security threats within the at least one screening lane, and a processing unit configured to be operatively coupled to the at least one external screening device and the plurality of lane screening devices. The method further includes locating the hub unit at a point of entry to the venue and operating the processing unit of the hub unit by receiving data from the at least one external screening device and the plurality of lane screening devices. The method includes operating the processor to characterize the received data as being indicative of one or more security threats or a non-security condition and, if the received data is indicative of one or more security threats, outputting a notification that identifies the one or more security threats.

Various additional features and advantages of the invention will become more apparent to those of ordinary skill in the art upon review of the following detailed description of one or more illustrative embodiments taken in conjunction with the accompanying drawings.

### BRIEF DESCRIPTION OF THE DRAWINGS

The accompanying drawings, which are incorporated in and constitute a part of this specification, illustrate one or more embodiments of the invention and, together with the general description given above and the detailed description given below, serve to explain the one or more embodiments of the invention.

FIG. 1 is a diagrammatic top view of a mobile security system deployed at a venue according to an embodiment of the present invention.

FIG. 2 is a system block diagram of an example communication network for the mobile security system of FIG. 1.

FIG. 3 is a front view of a hub unit of the security system of FIG. 1 according to an embodiment of the present invention.

FIG. 4A is a perspective view of the hub unit of FIG. 3, illustrating display screens pivoted to an extended position.

FIG. 4B is a view similar to FIG. 4A, illustrating the display screens pivoted to a stowed position for transportation of the hub unit.

FIG. 5 is a rear perspective view of the hub unit.

FIG. 6 is an enlarged top view, shown in partial cross-section, of a first end wall of the hub unit, illustrating pivotal movement of a side display screen.

FIG. 7 is an enlarged side view, shown in partial cross-section, of a top wall of the hub unit, illustrating pivotal movement of a top display screen.

FIG. 8 is an enlarged top view of the hub unit, illustrating details of three exemplary screening lanes according to an embodiment of the present invention.

FIG. 9 is a top view of the hub unit, illustrating wiring connections for two exemplary screening lanes according to an embodiment of the present invention.

FIG. 10 is a schematic cross-sectional view, taken along line 10-10 of FIG. 3, illustrating wireways for the hub unit according to an embodiment of the invention.

FIG. 11 is a front perspective view of a hub unit in accordance with another embodiment of the present invention.

FIGS. 12A and 12B are perspective views of a hub unit in accordance with another embodiment of the present invention.

FIGS. 13A and 13B are perspective views of a hub unit in accordance with another embodiment of the present invention.

### DETAILED DESCRIPTION

Aspects of the present invention are directed to a mobile security system for managing pedestrian entry into a venue. In this regard, components of the security system may be easily assembled, disassembled, and transported from and to a variety of different venue locations, both indoor and outdoor. In some cases, the security system may be a permanent or semi-permanent installation, if desired. In any event, once deployed at a venue, the security system both screens pedestrians seeking to enter the venue for security threats and manages pedestrian activity from a perimeter of the venue to a point of entry to the venue. The security system also serves as an access point to the venue and further screens the pedestrians for security threats as they pass through the security system and into the venue. In this regard, the system includes at least one main hub unit configured to be located near the entry point to the venue through which pedestrians pass to enter the venue. The hub unit is configured to screen pedestrians as they pass therethrough for a number of different security threats, as will be described in further detail below. The security system may optionally include one or more connected perimeter units, each configured to be located in a space between the perimeter and entry point to the venue to thereby scan for security threats as pedestrians move within this space and toward the hub unit and venue entry point. As described in further detail below, the hub unit and optional perimeter units are equipped with a number of security screening devices that provide for touchless threat detection and monitoring of individuals and their activities as they move from the perimeter of the venue and into the venue. To this end, the system is equipped with multi-threat screening technologies powered by one or more integrated artificial intelligence (AI) software platforms configured to analyze and characterize data received by the multiple screening devices connected to the system as being indicative of one or more security threats. Upon detection of a security threat, the system may also notify local and/or remote personnel for action. To this end, the security system and its subsystems conduct a primary screening of individuals for security threats. The primary screening operations are touchless, as described in further detail below. Once an individual is associated with a security threat detected by the security system, secondary screening of that individual may be necessary. Secondary screening might include a pat-down to remove a weapon or other contraband from the individual or a full body scan using a hand-held metal detector, for example.

By touchless, it is meant that individuals moving from the perimeter of the venue to the point of entry to the venue are not touched or contacted, so as to feel the contact, or do not affirmatively interact with any of the screening devices to be screened for security threats. Touchless further means that as individuals move through the hub unit, they are not touched or contacted, so as to feel the contact, by any of the screening devices to be screened for one or more security threats. Individuals may be required to walk over or past screening devices, but for purposes of this disclosure, that is considered to be passive interaction with those screening devices and thus touchless. Further, individuals may be required to interact with one or more systems to confirm identification (e.g., scan a ticket, phone, driver's license, or other form of identification). While this type of interaction is typically touchless, it may require minimal affirmative contact by the individual with a device (e.g., to press a phone or ticket against a screen). However, touchless means that individuals are not required to move objects such as a turnstile, to be pat down, or to be physically contacted by a screening device such as a hand-held metal detector, which are each examples of non-touchless screening measures, to be screened for security threats.

As will become more clear below, the mobile security system is capable of screening for and detecting security threats in crowded, high clutter environments, in which numerous individuals may be carrying personal items such as bags, cell phones, purses, wallets, etc. and without the need for divestment of these and other personal items. The mobile security system is further capable of performing threat screening and detection with high through-put that allows individuals to move from the perimeter of the venue and into the venue at a normal walking pace while continuously being monitored and screened for security threats by the security system. In this regard, the hub unit is configured to screen multiple individuals at a time as they pass therethrough which allows for more throughput into the venue and less delay for screening operations. To this end, the security systems can be sized to handle speedy, high-throughput, touchless screening of small, medium, or large quantities of individuals seeking to enter a venue. The security system may screen thousands of individuals per hour. For example, each screening lane may screen anywhere between 1,000 to 1,500 individuals per hour, and more particularly, between 1,200 to 1,300 individuals per hour. Further, the security system is configured for touchless, and in some embodiments even human-less, non-discriminative screening of people for security threats which can include safety, health, and/or identification, for example, before being granted entry into the venue. These and other aspects of the invention will be expounded in the description that follows.

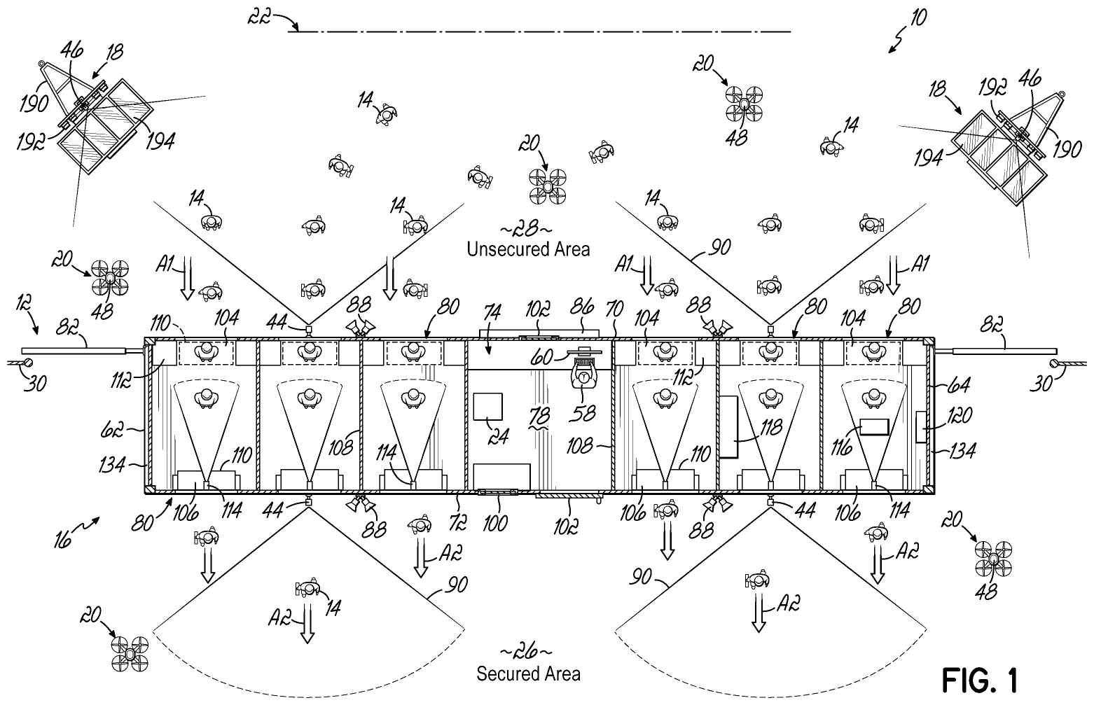

With reference to FIG. 1, a mobile security system 10 according to an exemplary embodiment of the invention is shown deployed at a venue and near a point of entry 12 to the venue. The mobile security system 10 is deployed to screen for security threats and to manage the activities of one or more individuals 14, whom may collectively form a crowd of individuals, as they progress toward the point of entry 12 and eventually into the venue. It is understood that the venue may include any outdoor or indoor venue such as a stadium, fairgrounds, golf course, race track, or other outdoor or indoor space where sporting events, parades, concerts, or festivals are held, or any other space such as a military base where security screening of entrants is required for entry. However, while the mobile security system 10 is shown and described in the context of a venue where tickets may be required to enter, such as a sporting event, it will be understood that the same inventive concepts related to the mobile security system 10 may be implemented with all types of venues without departing from the scope of the invention. More particularly, in its broader aspects, the inventive concepts related to the mobile security system 10 may be implemented with any type of venue where crowds of people gather. To this end, the drawings are not intended to be limiting.

As shown in FIG. 1, the mobile security system 10 includes a number of interconnected subsystems such as at least one portable hub unit 16, one or more portable perimeter units 18, and one or more drones 20, for example, each being configured to screen individuals 14 and their activities, or their collective activities, for security threats as they move from a perimeter 22 of the venue to the point of entry 12 and eventually into the venue. These subsystems of the security system 10 may be connected, in a wireless or wired mode, to appropriate control electronics, such as a processing unit 24 configured to receive data from a number of sensors and screening devices associated with each subsystem. As described in further detail below, the security system 10 employs one or more integrated AI-driven software platforms, stored on the processing unit 24 or remotely on a server to which the processing unit 24 is connected, that are configured to analyze the data received from the hub unit 16, each perimeter unit 18, and each drone 20, and to further classify the data received as being indicative of either a security threat or a non-threat. Generally speaking, a security threat can be considered any individual, action, object, element, or characteristic thereof, passing through the security system 10 which, if allowed to enter a secured area 26 of the venue, can cause damage, introduce security concerns or health-related concerns, and/or otherwise disrupt events or activities occurring in the secured area 26 of the venue or near the venue in an unsecured area 28.

With continued reference to FIG. 1, the hub unit 16 is shown installed at the point of entry 12 to the venue and may effectively function as a barrier between the venue and the perimeter 22 of the venue through which individuals 14 must pass to enter the venue. The hub unit 16 may be deployed in such a way so as to become part of a security fence 30 that surrounds the venue to ensure no individuals 14 can pass between the hub unit 16 and the security fence 30. As shown, the hub unit 16 separates the secured area 26 of the venue from the unsecured area 28. The secured area 26 is a space within the confines of the venue where venue related activities occur. The unsecured area 28 is a space outside the confines of the venue and between the point of entry 12 to the venue and the perimeter 22 of the venue. Within the unsecured area 28 there may be, for example, parking lots, walkways, or other similar areas from which individuals 14 originate to enter the venue. The unsecured area 28 is where the one or more perimeter units 18 and drones 20 are located to screen for security threats. However, it is possible to locate one or more perimeter units 18 and/or drones 20, exclusively or additionally, in the secured area 26 to screen for security threats. In one embodiment, the system 10 may include ground-based autonomous robots instead of drones 20. In any event, the hub unit 16, perimeter unit(s) 18, and drone(s) 20 continuously screen individuals 14 seeking to enter the venue for security threats as they move within the unsecured area 28 and toward the secured area 26, as indicated by directional arrows A1. The hub unit 16 then conducts a more thorough security screening of each individual 14 as they move through the hub unit 16 at the point of entry 12 to the venue and into the secured area 26, as indicated by directional arrows A2. To this end, while the exemplary hub unit 16 shows individuals 14 passing therethrough in a linear way (e.g., in a straight line through the hub unit 16), it is understood that individuals may enter or exit the hub unit 16 in other ways, such as at an angle relative to the hub unit 16 if needed to accommodate different venue layouts. Furthermore, it is understood that the hub unit 16 could be configured in different ways so that individuals 14 enter and/or exit the hub unit 16 on a side of the hub unit 16, for example.

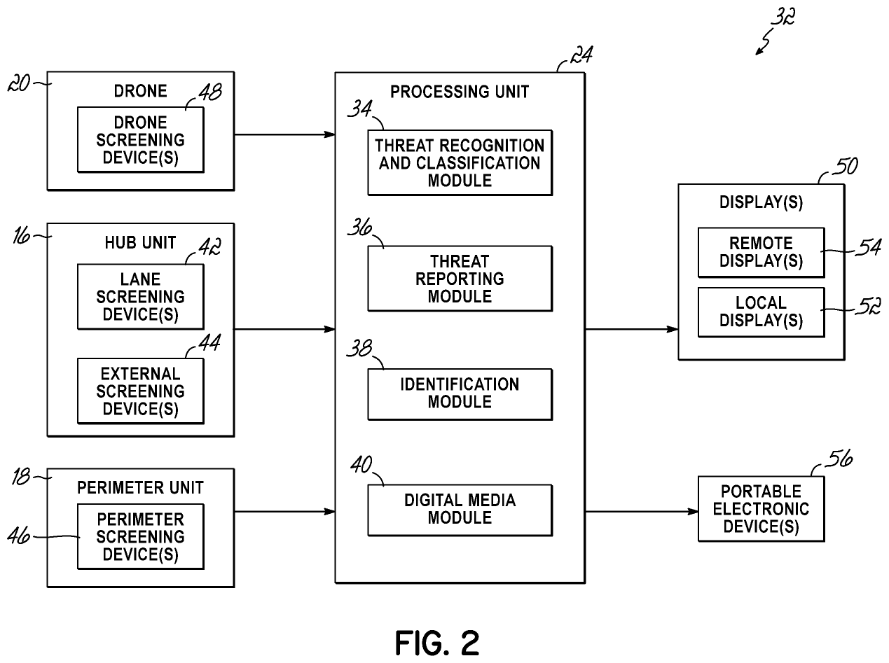

As briefly described above, the processing unit 24 is operatively coupled to the hub unit 16, the one or more perimeter units 18, and the one or more drones 20, to receive data from those devices including certain screening devices associated with those systems. In this regard, FIG. 2 is a block diagram illustrating an example communication network 32 for the mobile security system 10 shown in FIG. 1. The processing unit 24 includes one or more processors having at least a threat recognition and classification module 34, a threat reporting module 36, an identification module 38, and a digital media module 40.

As shown in FIG. 2, the processing unit 24 is coupled to the hub unit 16 to receive data from the hub unit 16. More particularly, the processing unit 24 is configured to receive data from one or more lane screening devices 42 and one or more external screening devices 44 associated with the hub unit 16, as will be described in further detail below. The processing unit 24 is also coupled to the one or more perimeter units 18 and one or more drones 20 to receive data from those systems. More particularly, the processing unit 24 is configured to receive data from one or more perimeter screening devices 46 associated with the one or more perimeter units 18, and one or more drone screening devices 48 associated with the one or more drones 20, as will be described in further detail below. The processing unit 24 then characterizes the received data using the threat recognition and classification module 34 as being indicative of one or more security threats or a non-security threat. If the received data is characterized as being indicative of a security threat, the threat reporting module 36 is used to output a notification or alert that identifies the one or more security threats, as described below.

One or more display(s) 50 are coupled to the processing unit 24 and configured to receive data from the processing unit 24. The one or more displays 50 include at least one local display 52 and/or at least one remote display 54. The displays 50 may be connected to the processing unit 24 in a wireless or wired mode. The at least one local display 52 may be located within or on an exterior of the hub unit 16, for example. The at least one remote display 54 may be located away from the hub unit 16, such as in an office within the venue or a remote location away from the venue, for example. Further, at least one portable electronic device 56 is coupled to the processing unit 24 to receive data therefrom. The display(s) 50 and portable electronic device(s) 56 may be used by one or more security personnel 58 (shown in FIG. 1) to monitor screening operations for the security system 10. Those skilled in the art will easily understand that any of the display(s) 50 may be implemented as an analog TV, a digital TV, a 3D TV, a smart TV, an LED TV, an OLED TV, a plasma TV, a monitor, a curved TV having a screen with a fixed curvature, a flexible TV having a screen with a fixed curvature, a bent TV having a screen with a fixed curvature, and/or a variable curvature TV in which the curvature of a current screen can be changed by an input received from the user, or other similar means, but is not limited thereto.

With continued reference to FIG. 2, the details of the processing unit 24, and more particularly each module 34, 36, 38, 40, will be described in additional detail. The threat recognition and classification module 34 may comprise numerous integrated AI-driven software platforms to analyze and classify the data received from the hub unit 16, drone(s) 20, and perimeter unit(s) 18, as being indicative of a security threat. In this regard, the threat recognition and classification module 34 may include software platforms commercially available from Patriot One Technologies (located at 750-1095 West Pender Street Vancouver, BC V6E 2M6 Canada), such as, PATSCAN VRS-W video weapon detection software used to analyze images and video feeds for exposed weapons, PATSCAN VRS-T elevated body temperature screening and identification used to analyze received body temperature data indicative of a fever related virus or contagion, PATSCAN MSG concealed weapon detection software used to analyze data received for concealed weapon threats, and the PATSCAN VRS-HS facial mask detection module used to analyze images and video feeds for facial mask compliance, for example. The threat recognition and classification module 34 may further incorporate additional software platforms such as those offered by Smiths Detection (located at 2202 Lakeside Boulevard Edgewood, MD 21040 USA) used to analyze data received as being indicative of a biohazard or radiation security threat, as well as data received from X-ray screening devices, as will be described in further detail below. To this end, the threat recognition and classification module 34 may employ other software platforms such as the crowd management intelligence technology commercially available from WaitTime (located at 1700 Great Fosters Court, Oakland Township, Rochester, MI, 48306, USA), for example. The threat recognition and classification module 34 may be configured to anonymize screening data, if desired.

The threat recognition and reporting module 34 is configured to classify the data received from the one or more screening devices 42, 44, 46, 48 as being indicative of the following security threats: a concealed weapon threat, an exposed weapon threat, a bomb threat, a biohazard threat, a personal protective equipment non-compliance, an elevated body temperature for an individual 14, and a crowd disturbance event. Each of these security threats will be described in additional detail below with respect to the individual screening devices.

The threat reporting module 36 is configured to output an alert or notification if data received is classified as being indicative of one or more security threats. In this regard, the threat reporting module 36 may be configured to communicate alerts and notifications directly to one or more displays 50, or a user interface in the form of a digital or software application on the display(s) 50 and/or portable electronic device(s) 56 through which security personnel 58 may be alerted to control, monitor, or otherwise engage with the security system 10. The user interface may also allow for location-based tracking of the hub unit 16, perimeter unit(s) 18, and/or drone(s) 20. In addition to outputting an alert, the threat reporting module 36 may also be configured to capture a facial image of the one or more individuals 14 associated with the security threat. The facial image may be used to assign an identifier to the one or more individuals 14. That way, the individual(s) 14 may be tracked or monitored via additional video feeds in the venue, if available.

As will be described in further detail below, the identification module 38 is used to confirm the identification of an individual 14 for admittance into the venue, particularly as they pass through the hub unit 16. In this regard, the identification module 38 may include a facial recognition platform and/or a ticket scanning and confirmation platform, for example. The facial recognition platform is used to confirm identity of an individual 14 via biometrics such as fingerprints, eye(s), and/or an individual's 14 face, and may comprise software platforms such as Clear which is commercially available from Secure Identity, LLC (located at 650 5th Ave., 12th Floor, New York, 10019, NY, USA). To this end, the identity of an individual 14 can be confirmed and/or tracked to the individual's 14 ticket, for example, using the identification module 38. The digital media module 40 is configured to transmit data in the form of messages, pictures, videos, audio, ads, advertising, and other related content to one or more of the connected displays 50. In this regard, the digital media module 40 may include a digital media network component, such as those commercially available from TruClear Global (located at 3901 Westerly Pl, Newport Beach, CA 92660, USA).

In one embodiment, program code for one or more processors associated with the modules 34, 36, 38, 40 may be stored directly on the processing unit 24. Alternatively, the program code may be stored remotely on a server and accessible by the processing unit 24 which is operatively connected via a network connection to the server. In another embodiment, the processing unit 24 may be located in another location on the hub unit 16, such as on the top wall 66, for example. The processing unit 24 may also be located at a remote location from the hub unit 16, such as on a server. In any event, the processing unit 24 may include one or more devices selected from processors, microprocessors, micro-controllers, digital signal processors, microcomputers, central processing units, field programmable gate arrays, programmable logic devices, state machines, logic circuits, analog circuits, digital circuits, or any other devices that manipulate signals (analog or digital) based on operational instructions stored in memory. Memory may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, or data storage devices such as a hard drive, optical drive, tape drive, volatile or non-volatile solid state device, or any other device capable of storing data. The processing unit 24 may operate under the control of an operating system that resides in memory. The operating system may manage computer resources so that computer program code embodied as one or more computer software applications, such as those associated with the modules 34, 36, 38, 40, may have instructions executed by the processing unit 24. One or more data structures may also reside in memory, and may be used by the processing unit 24 to store or manipulate data. The processing unit 24 may also be operatively coupled to one or more external resources via a network or I/O interface. External resources may include, but are not limited to, servers, databases, mass storage devices, peripheral devices, cloud-based network services, or any other resource that may be used by the processing unit 24.

Returning to FIG. 1, the processing unit 24 is shown connected to at least one Human Machine Interface (HMI) 60 located in the hub unit 16 configured to be used by security personnel 58 to monitor the system 10 health and security screening operations of the system 10. The HMI 60 may include video or alphanumeric displays, a touch screen, a speaker, and any other suitable audio and visual indicators capable of providing data to the security personnel 58. The HMI 60 may also include input devices and controls such as an alphanumeric keyboard, a pointing device, keypads, pushbuttons, control knobs, microphones, etc., capable of accepting commands or input from the security personnel 58 and transmitting the entered input to the processing unit 24. To this end, the HMI 60 may be classified as being one of the at least one local displays 52 shown in FIG. 2.

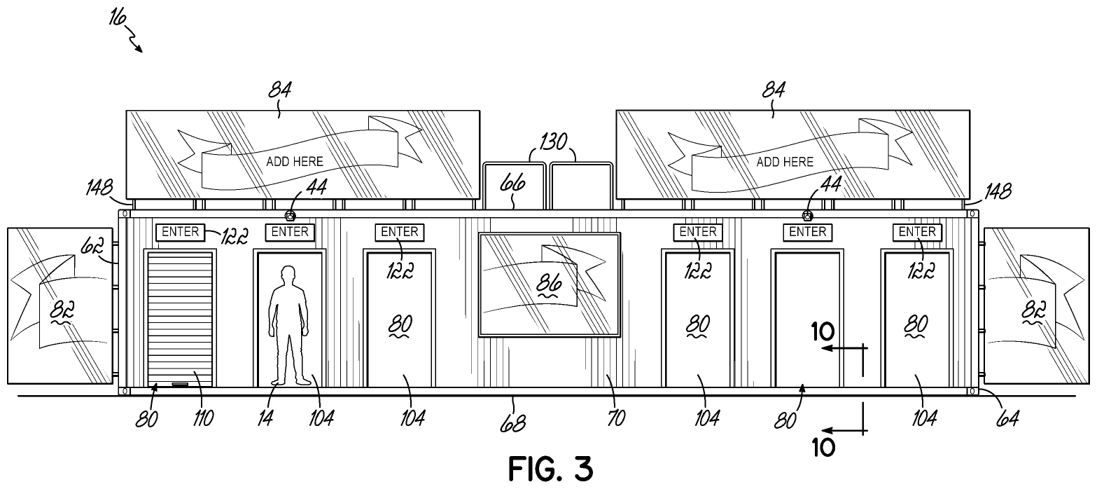

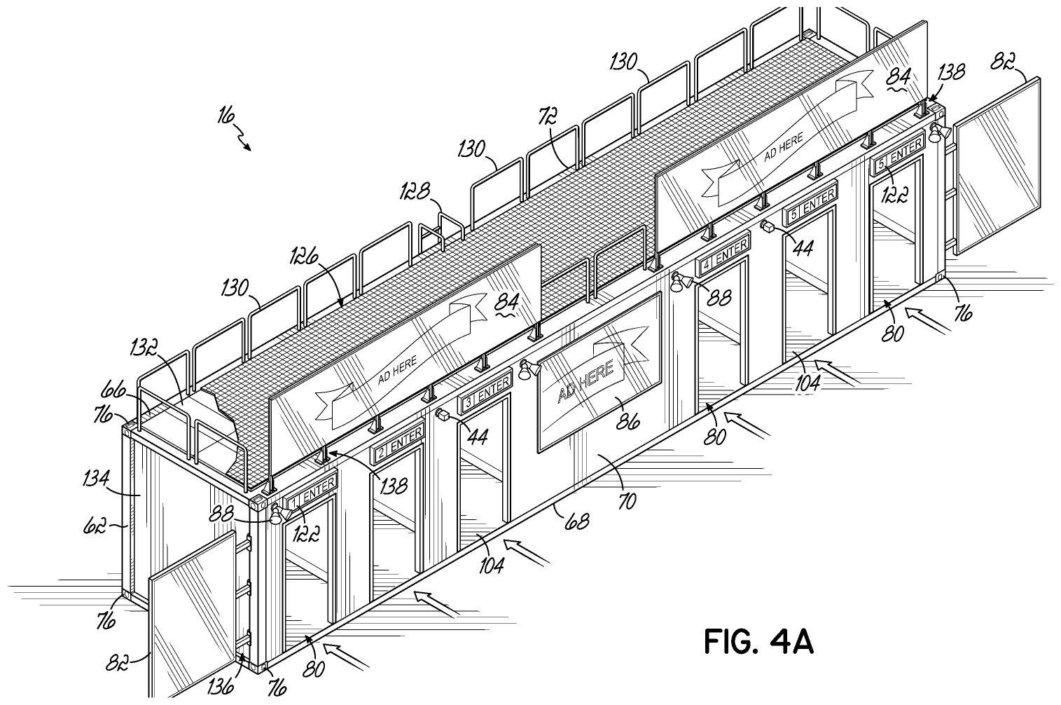

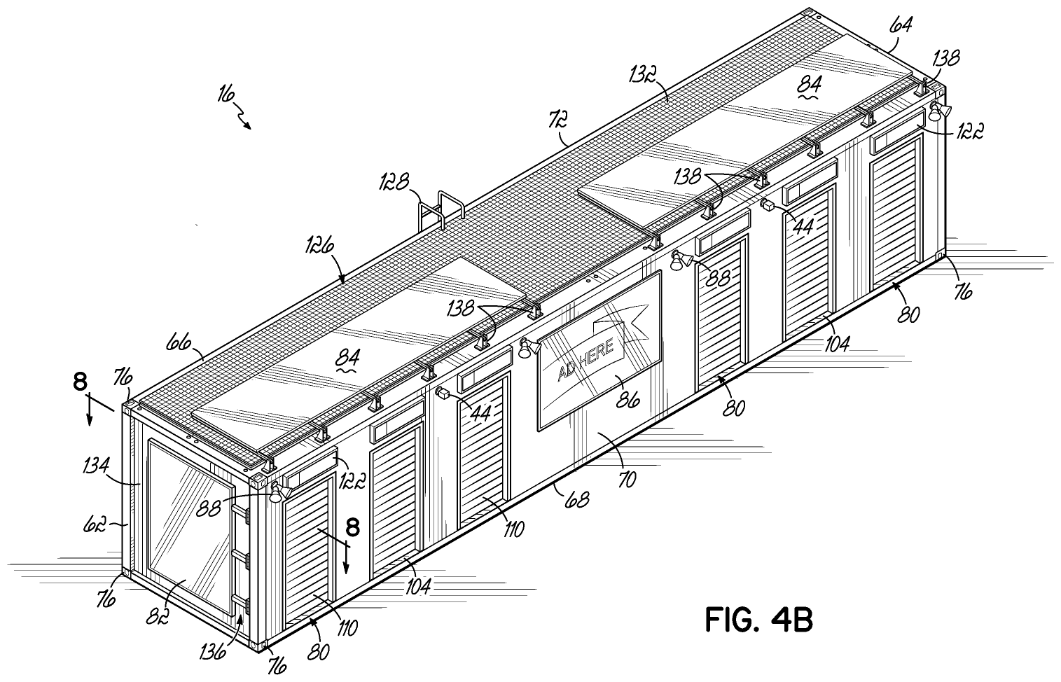

Referring now to FIGS. 3 through 5, and with continued reference to FIG. 1, details of the hub unit 16 will now be described. As shown, the hub unit 16 is generally rectangular in shape and has a first end wall 62 and a second end wall 64 between which a top wall 66, a bottom wall 68, a front wall 70, and a back wall 72 extend to define an interior 74 of the hub unit 16. According to one embodiment of the invention, the walls 62, 64, 66, 68, 70, 72 of the hub unit 16 may each be formed from interconnected framing members (e.g., vertical studs and horizontal supports) that support metal paneling or any other durable material to enclose the hub unit 16 and enable the hub unit 16 to be towed or hoisted onto a trailer for transportation between venues, for example. In this regard, the top wall 66 of the hub unit 16 includes lifting blocks 76 (FIGS. 4A-4B) at each corner that can be used to secure the hub unit 16 to compatible lifting equipment. However, lifting blocks 76 may be included at all corners of the hub unit 16. The walls 62, 64, 66, 68, 70, 72 may further include weather and abrasion resistant protective coating, particularly if the hub unit 16 is to be located outdoors. For example, the protective coating may be the FULL METAL JACKET™ Plus coating material that is commercially available from Specialty Products, Inc (located at 2410 104th St. Lakewood, Washington, 98499, USA).

The hub unit 16 further includes a control room 78 and a plurality of touchless screening lanes 80 located within the interior 74 of the hub unit 16. As best shown in FIG. 1, each screening lane 80 defines a separate walkable path through the hub unit 16. As briefly described above, each screening lane 80 includes a plurality of lane screening devices 42 each being operatively coupled to appropriate control electronics, such as the processing unit 24, for example, which may be located in the control room 78. Further, the hub unit 16 includes a number of illuminated display devices 50 operatively coupled to the processing unit 24 and configured to present marketing, advertisement, promotional materials, or other notifications to venue entrants as they enter the venue via the digital media module 40, as described above. More particularly, as shown in FIG. 3, the hub unit 16 includes two side displays 82, two top displays 84, and one front display 86. The illuminated display devices 82, 84, 86 may each be considered as being one of the at least one local display 52 shown in FIG. 2. For a venue with a security fence 30, each side display 82 may be coupled to, or in an overlapping relationship with, the security fence 30 to prevent individuals 14 from circumventing the hub unit 16.

The front 70, back 72, and/or end walls 62, 64 of the hub unit 16 may also include one or more external lighting devices 88, and/or external screening devices 44 each operatively coupled to the processing unit 24. The lighting devices 88 may be located on the front and back walls 70, 72 of the hub unit 16. The lighting devices 88 may be remotely controllable from the processing unit 24, and may further be configured to automatically adjust the light output (i.e., lumens) to improve the performance of one or more screening devices 42, 44, 46, 48 connected to the security system 10, for example. The one or more external screening devices 44 may be located on the front 70, back 72, and end walls 62, 64 of the hub unit 16, for example. More particularly, the external screening devices 44 are used to screen for security threats, such as an exposed weapon threat and/or crowd disturbance event, for example, external to the hub unit 16 and within the unsecured area 28 and/or secured area 26. A crowd disturbance event might be a fight or other aggressive behavior by one or several individuals 14 that might threaten the safety of nearby onlookers. In any event, the external screening devices 44 may include a wide-angle digital camera or digital video camera with infrared, thermal, electro-optical capabilities, and/or speakerphone capabilities for example, having a detectable area 90. In one embodiment, the speakerphone may be used to issue communications to individuals 14 and/or screen conversations of individuals 14 which includes detecting the use of certain threat words such as “bomb,” “gun,” “ammo,” or “knife,” for example. To this end, it is desirable to provide partial to full video coverage of the unsecured area 28 and of the secured area 26. Thus, as individuals 14 approach and walk through the screening lanes 80, the external screening devices 44 and the plurality of lane screening devices 42 associated with each screening lane 80 are operated to screen the individuals 14 for a number of different security threats, as described in further detail below.

As briefly described above, the hub unit 16 further includes the control room 78, or office, located within the interior 74 of the hub unit 16. As best shown in FIG. 1, the control room 78 is an enclosed space separate from the plurality of screening lanes 80 and includes a lockable access door 100 located in the back wall 72 of the hub unit 16 and one or more windows 102 in the front wall 70 and/or back wall 72 of the hub unit 16. The access door 100 may be a ballistic resistant door with one or more locking mechanisms configured to engage with the back wall 72 of the hub unit 16 to lock the door 100. The windows 102 may be configured as a one-way window to allow security personnel 58 to see out of the windows 102 yet prevent individuals 14 standing outside of the control room 78 from seeing inside the control room 78. In the embodiment shown, the control room 78 is situated in the middle of the hub unit 16 and extends from the front wall 70 to the back wall 72 of the hub unit 16. The control room 78 may have three screening lanes 80 on either side, for example. However, the control room 78 may be larger, smaller, or located elsewhere within the hub unit 16, such as adjacent to either end wall 62, 64 of the hub unit 16. In one embodiment, the hub unit 16 may not have the control room 78. In another embodiment, the control room 78 may be external to the hub unit 16, and may be located at a remote location or positioned above the hub unit 16 on the top wall 66, for example. If the control room 78 is located remotely from the hub unit 16, the security screening operations of individuals 14 by the security system 10 may be conducted in a human-less manner. Human interaction with individuals 14 would only be needed when a security threat is detected, for example. In any event, the control room 78 is where the processing unit 24 may be located as well as other components such as an uninterrupted power supply, a WiFi access point, servers, and related networking hardware for the system 10. In an alternative embodiment, the control room 78 may include other aspects such as at least one bed, bathroom, and additional storage for food and supplies for long-term security operations, for example.

As shown in FIG. 1, when the hub unit 16 is positioned at the point of entry 12 to the venue, the front wall 70 is configured to face the unsecured area 28 outside of the venue and the back wall 72 is configured to face the secured area 26 inside the venue. In this regard, each of the plurality of touchless screening lanes 80 extends from an entrance 104 to each screening lane 80 in the front wall 70 of the hub unit 16 to an exit 106 in the back wall 72 of the hub unit 16. Each screening lane 80 is separated by side walls 108 to create a walled passageway, or path, for each screening lane 80 through the hub unit 16 from the unsecured area 28 outside of the venue to the secured area 26 inside the venue through which an individual 14 passes to enter the venue. As shown, the side walls 108 are generally parallel to one another and generally aligned with the flow of individuals 14 through the hub unit 16. However, the side walls 108 may be configured in other ways. For example, the side walls 108 for each screening lane 80 may be non-parallel such that they proceed at an angle between entrance 104 and exit 106 to each screening lane 80. In this regard, the side walls 108 may generally narrow or widen so as to be V-shaped. In another embodiment, the side walls 108 may each include multiple angles, or curves, such that the path between the entrance 104 and exit 106 for one or more screening lanes 80 is non-linear in shape, or labyrinth-like. To this end, a screening lane 80 can be configured to have one or more turns, or a gentle curve, to facilitate security screening of individuals 14, for example.

To facilitate ingress and egress, each screening lane 80 may further include a ramp located at the entrance 104 and exit 106 thereto. Alternatively, the hub unit 16 may sit level with a ground surface such that there is generally no step up or down to each screening lane 80. While hub unit 16 illustrated includes six screening lanes 80, it is understood that the hub unit 16 can have fewer or more screening lanes 80 as desired. For example, the hub unit 16 may comprise just one screening lane 80 or, alternatively, ten or twelve screening lanes 80, for example. Further, each screening lane 80 may include an automatic roll-up door 110 installed at the entrance 104 and exit 106 to the screening lane 80 to securely close all lane 80 openings when not in use and for transportation of the hub unit 16. In another embodiment, each roll-up door 110 may be replaced with a shutter door or rolling shutter door. The roll-up doors 110 may be operatively coupled to the processing unit 24 and controllable via the HMI 60, for example.

As briefly described above, each screening lane 80 includes a number of lane screening devices 42 configured to screen individuals 14 located within the screening lane 80 for security threats. More particularly, each screening lane 80 includes one or more of the following: a pair of magnetic radar posts 112 (otherwise referred to as Multi-Sensor Gateways), a wide-angle camera 114 or video camera with infrared, thermal, electro-optical, and/or speakerphone capabilities, a biohazard detection device 116, an X-ray imaging device 118, and/or a ticket scanning device 120. The details of each lane screening device 42 will be described in more detail below.

In the embodiment shown, each screening lane 80 is generally similar in shape and size. Further, each screening lane 80 includes the same screening devices 42 in the same relative locations within each screening lane 80 so that an individual 14 may enter any lane 80 and be screened for security threats in the same way as if that individual 14 were to enter any other lane 80. However, it should also be understood that this need not be the case. For example, one screening lane 80 may be fitted with different, that is, more, less, or different combinations of screening devices 42 compared to other screening lanes 80. One example of this may be where five lanes 80 of the hub unit 16 screen individuals 14 for security threats while the sixth lane 80 is configured to screen large bags or other luggage for security threats.

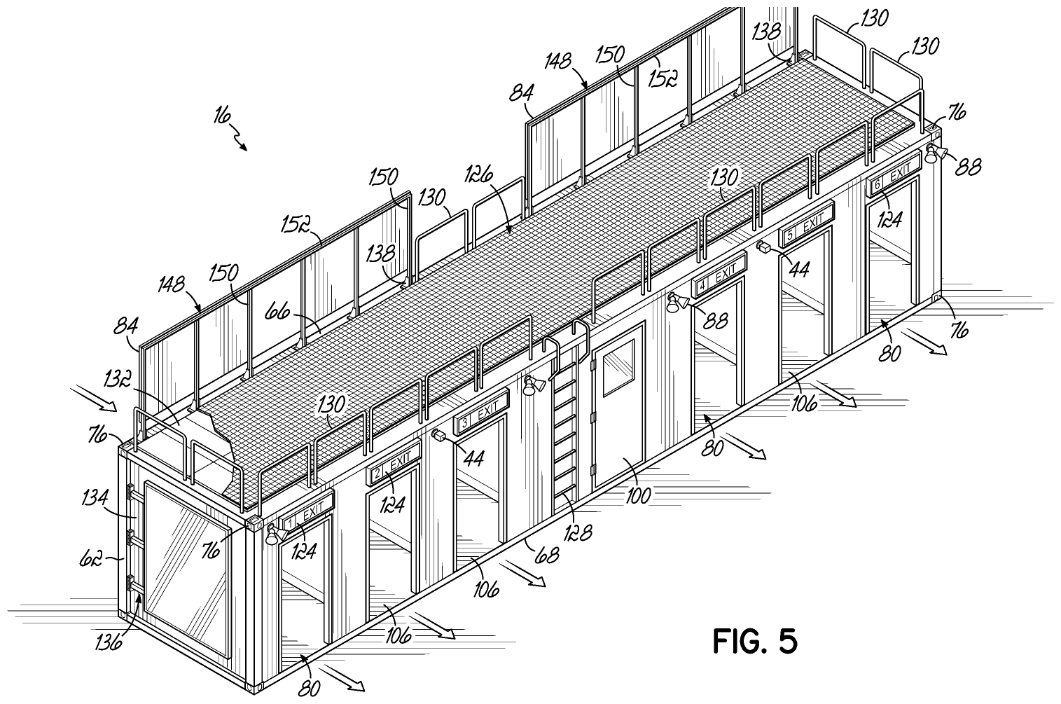

As best shown in FIG. 3, the front wall 70 of the hub unit 16 includes a display screen 122 located above the entrance 104 to each screening lane 80. The display screen 122 is configured to display a screening status of the corresponding screening lane 80. In this regard, each display screen 122 may each be considered as being one of the at least one local display 52 shown in FIG. 2. Each display screen 122 may be configured to display the screening status as an image, color, and/or text such as “enter”, “do not enter”, “closed”, “gate 1”, etc. As best shown in FIG. 5, the back wall 72 of the hub unit 16 may also include a display device 124 located above the exit 106 to each screening lane 80 to display a screening status of the corresponding screening lane 80, similar to the display screens 122 above each entrance 104. In this regard, the screening status may be an image, color, and/or text that indicates a screening status of an individual 14 in the screening lane 80, such as “red” which indicates a failed security screen or “green” otherwise. More particularly, the display screens 124 located on the back wall 72 of the hub unit 16 may be used to alert security personnel 58 to a screening lane 80 where an individual 14 failed a security screen, for example. Each display screen 122, 124 is operatively coupled to the processing unit 24, in a wired or wireless mode, and the processing unit 24 is programmed to operate the display screens 122, 124, which includes changing the screening status in response to a detected security threat (e.g., a failed security screen). For example, if received data from one or more of the lane screening devices 42 associated with a corresponding screening lane 80 is characterized by the processing unit 24 as being indicative of one or more security threats, the processing unit 24 may be programmed to change the screening status of the display device 122, 124 associated with the corresponding screening lane 80 to indicate a detected security condition.

With reference to FIGS. 3 through 5, the hub unit 16 includes a catwalk 126 positioned on the top wall 66 of the hub unit 16 and accessible via a ladder 128 located on the back wall 72 of the hub unit 16. As shown in FIG. 5, the ladder 128 is preferably located proximate to the control room access door 100 so that security personnel 58 may unobtrusively move between the control room 78 and the ladder 128 to access the catwalk 126. However, it is understood that the ladder 128 may be located elsewhere on the hub unit 16, such as either end wall 62, 64, for example. A perimeter of the catwalk 126 may be surrounded by a number of safety rails 130 removably mounted to the top wall 66 of the hub unit 16. The catwalk 126 enables a high vantage point for security personnel 58 to monitor individuals 14 as they make their way into the hub unit 16 and exit the hub unit 16 into the venue. The catwalk 126 may be formed from steel grating such as carbon steel grating, for example.

As shown, the hub unit 16 may also include one or more solar panels 132 located on the top wall 66 of the hub unit 16. More particularly, the solar panels 132 are installed between the top wall 66 of the hub unit 16 and the catwalk 126 which is configured to permit light flow therethrough. In this regard, it is desirable that the catwalk 126 be formed from grating or other suitable structure that permits ample sun light to pass therethrough. The one or more solar panels 132 are configured to generate electricity to power components of the hub unit 16. For example, the one or more solar panels 132 may be configured to power the entire hub unit 16, resulting in the hub unit 16 being self-sufficient. Alternatively, the solar panels 132 may provide power to a limited number of components of the hub unit 16 such as the display devices 50 or the at least one external screening device 44 and the plurality of lane screening devices 42, for example. The solar panels 132 may be further configured to provide power to these and other devices via ethernet cabling, otherwise referred to in industry as power over ethernet (PoE), which is the process of passing electricity through twisted-pair ethernet cable to powered devices. In another embodiment, where the hub unit 16 does not include solar panels 132, the display devices 50 and screening devices 42, 44 of the hub unit 16 may still be powered over ethernet cabling. PoE not only enables the possibility of network monitoring of the connected devices, but also reduces the electrical load and simplifies the electrical wiring of the hub unit 16. To this end, the hub unit 16 may be powered by a generator, battery, or linear power supply, for example. In one embodiment, the battery may be chargeable via the solar panels 132.

With reference to FIGS. 4A and 4B, the hub unit 16 includes the two side displays 82, two top displays 84, and the one front display 86 which are configured to present marketing, advertisement, promotional materials, or other notifications to individuals 14 as they enter the venue. More particularly, the side displays 82 and top displays 84 are each pivotably coupled to the hub unit 16. As shown the first end wall 62 and second end wall 64 each include one display 82 of similar size and the top wall 66 includes two displays 84 of similar size. The front display 86 may be non-pivotable and located on the front wall 70 of the hub unit 16 and near the control room 78, for example. To this end, it is preferable for the front display 86 to have a degree of translucency so that security personnel 58 in the control room 78 can see through the display device 86. To this end, the display device 86 may be mounted over the front-facing window 102 of the control room 78, for example.

With continued reference to FIGS. 4A and 4B, each of side and top displays 82, 84 are movable, or pivotable, between an extended position (illustrated in FIG. 4A) where each display device 82, 84 extends away from the one of either the first end wall 62, second end wall 64, or top wall 66, and a stowed position (illustrated in FIG. 4B) where each display device 82, 84 extends alongside the one of either the first end wall 62, second end wall 64, or top wall 66. To move the top displays 84 from the extended position to the stowed position, the safety rails 130 may be removed, as shown in FIG. 4B. As described in further detail below, the first end wall 62 and the second end wall 64 each include a recess 134 configured to receive, partially or fully, the corresponding display 82 therein. That way, the displays 82 are positioned generally flush with each side wall 62, 64 to prevent damage during transportation of the hub unit 16 between venues. In one embodiment, the hub unit 16 may further include protective covers configured to enclose each display 82 within the corresponding recess 134 for transportation and storage. To this end, the pivotal arrangement between each of these display devices 82, 84 and the hub unit 16 facilitates transportation of the hub unit 16. In this regard, FIG. 4B illustrates the hub unit 16 in a disassembled state for transportation, with all displays 82, 84 in the stowed position. As shown, when so positioned, the hub unit 16 has a generally rectangular profile that can be easily positioned on or within a trailer for transportation.

With continued reference to FIGS. 4A and 4B, each of the side display devices 82 are pivotably attached to the hub unit 16 with a plurality of brackets 136 and each of the top pivotable display devices 84 are attached to the hub unit 16 with a plurality of brackets 138. Each of the brackets 136, 138 define a respective pivot axis for each of the display devices 82, 84. Further one or all of the brackets 136, 138 for each display 82, 84 may be locked in place to prevent the displays 82, 84 from being pushed aside by an individual 14 seeking to circumvent the hub unit 16 to enter the venue. As shown, the brackets 136, 138 for each display 82, 84 are located on respective walls 62, 64, 66 near the front wall 66 of the hub unit 16. That way, the displays 82, 84 are front-facing when the hub unit 16 is deployed at a venue, as shown in FIG. 1, for example.

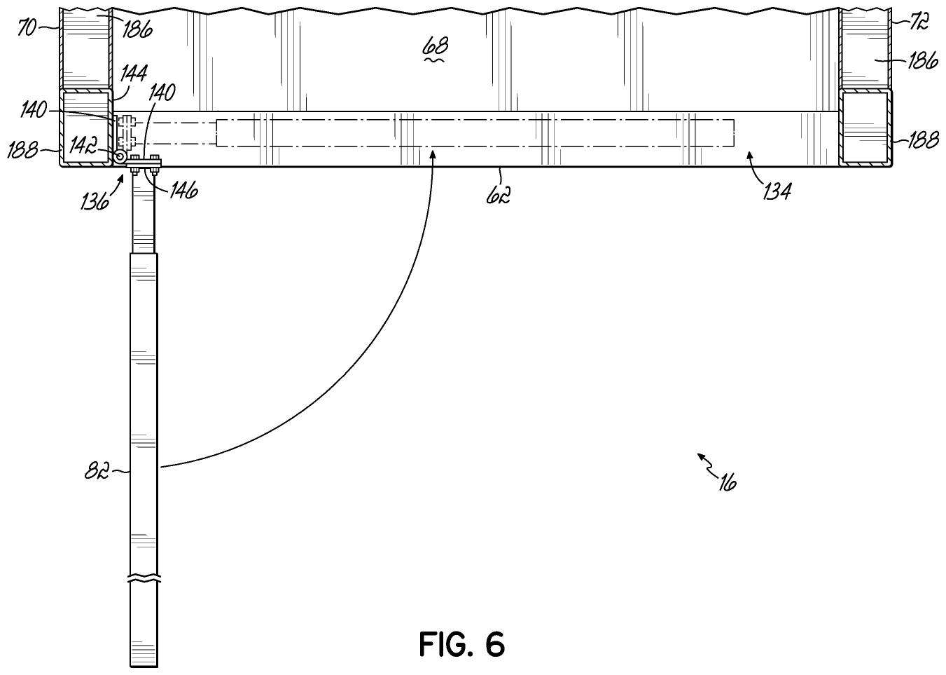

Turning now with reference to FIG. 6, the display 82 located on the first end wall 62 is shown including details of just one of the several brackets 136 used to pivotably couple the display 82 to the hub unit 16. As shown, the bracket 136 comprises two mounting plates 140 coupled together with a hinge pin 142 or other suitable structure. The hinge pin 142 may define the pivot axis for the display 82, for example. As shown, one of the mounting plates 140 is coupled to a surface 144 of the first end wall 62 that forms part of the recess 134. In this regard, the surface 144 may be part of a vertical support member at a corner of the hub unit 16, for example. The other one of the mounting plates 140 is coupled to an edge surface 146 of the display 82. The mounting plates 140 may be coupled to the display 82 and hub unit 16 with a bolt, nut and bolt combination, or other suitable structure. As shown, the bracket 136 is mounted to the hub unit 16 so as to be located within the recess 134 to thereby permit pivotal movement of the display 82 between the stowed position (e.g., the display 82 is located within the recess 134, as shown in dashed lines in FIG. 6) and the extended position (e.g., the display 82 is located outside of the recess 134 and extending generally perpendicular to the first end wall 62). To this end, while details of one bracket 136 are shown and described with respect to the display 82 located on the first end wall 62, it is understood that the display 82 located on the second end wall 64 is coupled to the second end wall 64 with brackets 136 in a similar way.

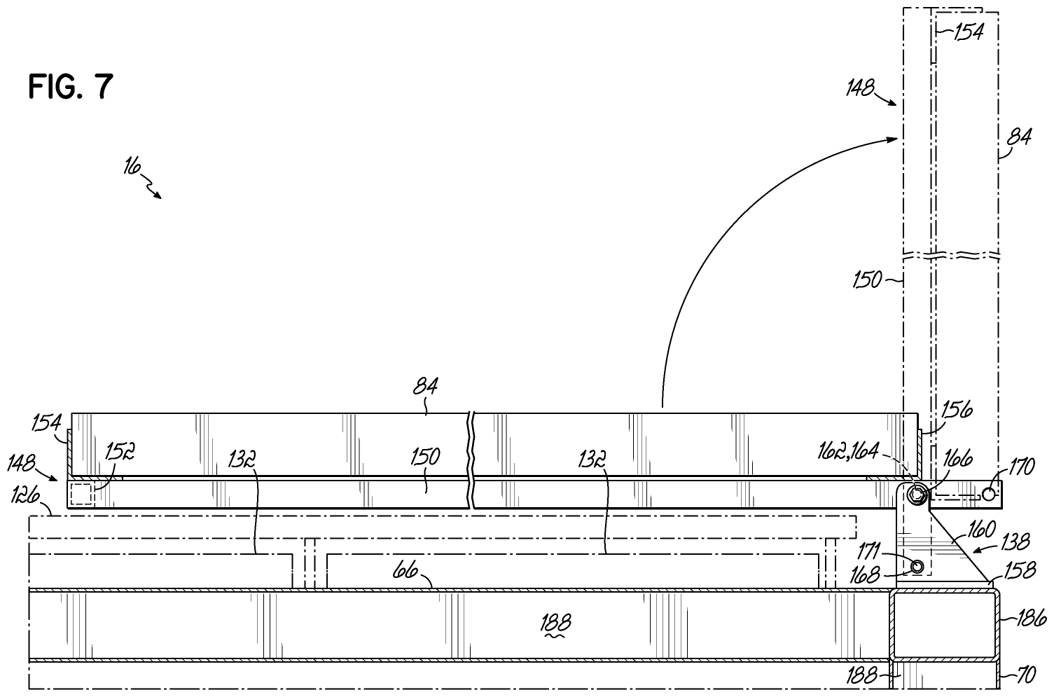

Turning now to FIG. 7, one of the displays 84 located on the top wall 66 is shown including details of just one of the several brackets 138 to which a frame 148 used to support the display 84 is pivotably coupled. In this regard, the display 84 is supported from the top wall 66 of the hub unit 16 by the frame 148 which is formed from several connected vertical members 150 and at least one horizontal member 152. More particularly, the frame 148 includes an upper L-shaped support member 154 and a lower L-shaped support member 156 to which the display 84 may be mounted to be supported by the frame 148. To this end, the display 84 extends between the upper and lower support members 154, 156. The vertical members 150 of the frame 148 are each coupled to a respective bracket 138 (shown in FIG. 5). Each bracket 138 includes a base 158 from which two triangle-shaped gussets 160 extend. The gussets 160 are spaced apart to receive a corresponding vertical member 150 of the frame 148 therebetween for coupling to the bracket 138. In this regard, as best shown in FIG. 7, each gusset 160 includes a first bore 162 configured to align with a corresponding first bore 164 through the vertical member 150 so that a nut and bolt combination 166, pin, or other suitable structure may be received therethrough to pivotably couple the vertical member 150 to the bracket 138. The nut and bolt combination 166 may define the pivot axis for the display 84, for example. To lock the display 84 in the extended position (as shown in FIG. 7 in dashed or phantom lines), the gussets 160 each include a second bore 168 configured to align with a second bore 170 through the vertical member 150 to receive a locking pin 171 such as a cotter pin, lock, nut and bolt combination, or other suitable structure therethrough to lock the display 84 in the extended position. To move the display 84 to the stowed position (shown in FIG. 7 in solid lines) the locking pins 171 may be removed from each of the brackets 138 and the display 84 pivoted back toward the hub unit 16. When in the stowed position, the frame 148 and display unit 84 extend along and are generally planar with the catwalk 126.

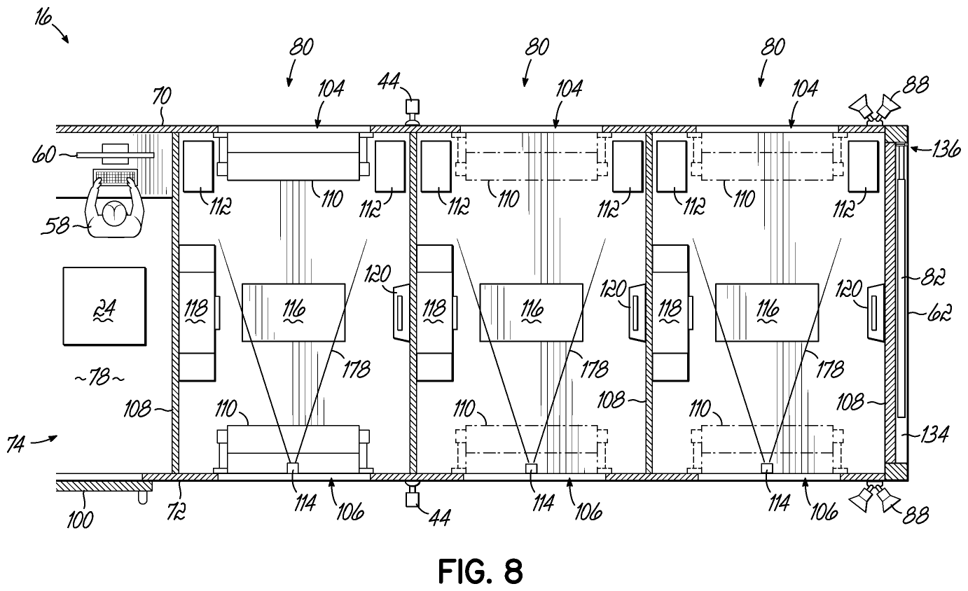

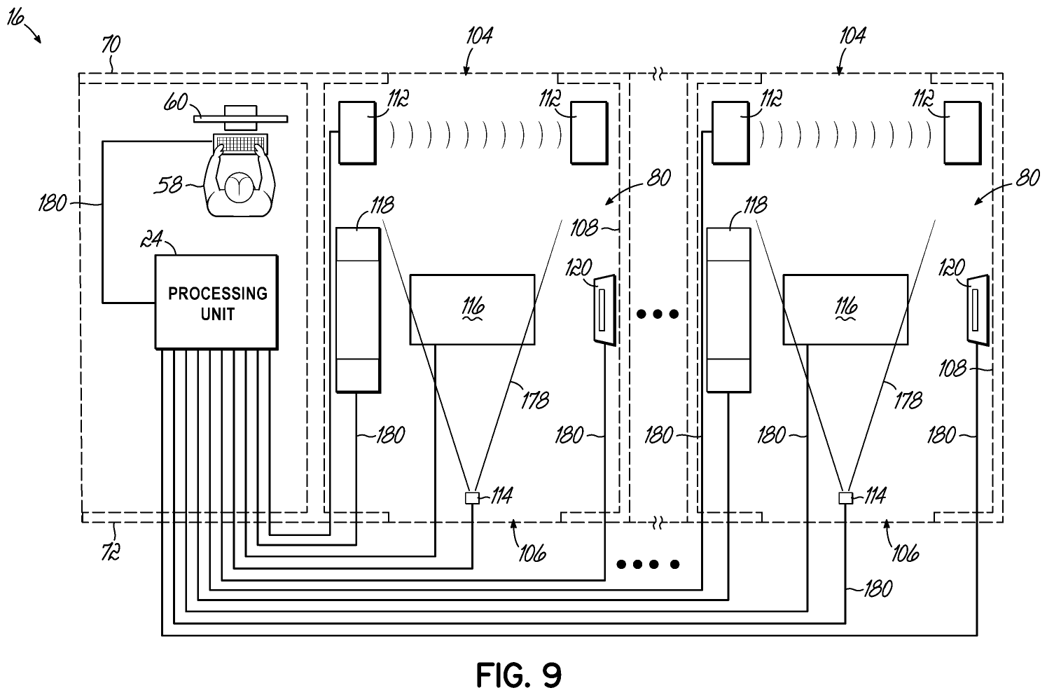

With reference to FIGS. 8 and 9, details of a select few exemplary screening lanes 80 are shown and will now be described. More particularly, the details of each lane screening device 42 will now be described. While only three screening lanes 80 are shown, it is understood that the shown screening lanes 80 are illustrative of all six screening lanes 80 of the hub unit 16, for example. As shown, each screening lane 80 includes the pair of magnetic radar posts 112 which are configured to detect concealed weapons and other weaponized threats on individuals 14 as they move through the screening lane 80. The pair of magnetic posts 112 are located inside the screening lane 80 near the entrance 104 to the screening lane 80 and proximate the unsecured area 28 such that an individual 14 walks between the posts 112 as they pass through the entrance 104 to each screening lane 80. For example, the posts 112 may be spaced one foot or less from the front wall 70 of the hub unit 16 and anywhere between 3 to 6 feet apart. The magnetic radar posts 112 use magnetic moment techniques to generate a resonant signature as an individual 14 walks through a space between the posts 12. The resonant signature can then be analyzed and classified by the threat recognition and classification module 34 as being indicative of a concealed weapon or other threat, for example. The detectable concealed weapons may include a barreled weapon such as a rifle (auto/semi-auto), shotgun, handgun, knife, a bomb (classifiable as a bomb threat), or any object that has an abnormal profile or material characteristic, for example. The pair of magnetic radar posts 112 may be the PATSCAN Multi-Sensor Gateway (MSG) 1.0 autonomous detection system commercially available from Patriot One Technologies, for example. To this end, the pair of magnetic radar posts 112 are configured to continuously or intermittently transmit data to the processing unit 24.

With continued reference to FIGS. 8 and 9, each screening lane 80 includes a video camera 114 located within the screening lane 80 and above the screening lane exit 106 to face toward the entrance 104 such that an individual 14 entering the screening lane 80 walks into a detectable area 178 of the video camera 114 almost immediately upon entering the screening lane 80. The video camera 114 may be a wide-angle video camera such that the detectable area 178 includes the entire screening lane 80. The video camera 114 also includes a thermal sensor configured to sense temperatures of objects located within the area 178 of the video camera 114, such as a body temperature of an individual 14 in the screening lane 80, for example. In one embodiment, the video camera 114 may be an FLIR-A400 thermal camera commercially available from Teledyne FLIR (located at 27700 SW Parkway Ave., Wilsonville, OR, 97070, USA). However, the video camera 114 may be equipped with additional abilities such as infrared and electro-optical sensing capabilities, for example. To this end, the video camera 114 is used to detect exposed weapon threats, a personal protective equipment non-compliance such as failure to wear a face mask, an elevated body temperature threat, and a crowd disturbance threat. The video camera 114 is configured to continuously or intermittently transmit data to the processing unit 24.

Each screening lane 80 may also be equipped with a biohazard detection 116 device for rapid detection of airborne contaminants. The biohazard detection device 116 may be a bio-aerosol collection and identification system configured to test air samples for a variety of biohazards and pathogens as individuals 14 pass through the screening lane 80. Examples of detectable biohazard threats include various diseases and common biothreat agents such as anthrax, ricin, botulinum toxin, black plague, tularemia, smallpox, and airborne SARS-CoV-2. Examples of detectable biohazard threats also include chemical and powder residue associated with bomb making or other chemical weapons, such as nitrogen-explosive compounds, for example. The biohazard detection device 116 may be the BioFlash Biological Identifier that is commercially available from Smiths Detection, for example. The biohazard device 116 is located on the bottom wall 68, such as the floor of each screening lane 80, and may comprise one or more air sample ports in the bottom wall 68 that are configured to draw air samples (via vacuum, for example) for each individual 14 that passes through the screening lane 80 and over the biohazard detection device 116. The air samples may then be analyzed using the biohazard detection device 116 and classified using the threat recognition and classification module 34. To analyze the samples, the biohazard detection device 116 includes an analyzer or detection chamber to which the air samples are routed for testing. The analyzer may be located in the control room 78 and the samples may be routed to the analyzer using appropriate tubing or piping, for example. In one embodiment, the analyzer for the biohazard detection device 116 may be part of the processing unit 24. To this end, the biohazard detection device 116 is configured to continuously or intermittently transmit data to the processing unit 24. In another embodiment, the biohazard device 116 may include air sample ports located elsewhere on the bottom wall 68, such as near the entrance 104 or exit 106 to the screening lane 80. The biohazard device 116 may include air sample ports located on a sidewall 108 of the screening lane 80, or at a joint between the sidewall 108 and the bottom wall 68, for example.

Each screening lane 80 may include a radiation detection device in addition to the biohazard detection device 116, or as an alternative. In the embodiment shown, the radiation detection device is a subsystem of the biohazard detection device 116. The radiation detection device may be similar to the RadSeeker portable radioisotope detector and identifier commercially available from Smiths Detection which is a radioisotope identifier. In this regard, the radiation detection device is configured to analyze the air samples drawn by the biohazard detection device 116 for gamma or neutron radiation above background. To this end, the biohazard detection device 116 is configured to continuously or intermittently transmit radiation test data to the processing unit 24. In an alternative embodiment, the radiation detection device may transmit data directly to the processing unit 24.

With continued reference to FIGS. 8 and 9, at least one screening lane 80 may include an X-ray detection device 118 used to screen personal items such as bags, purses, luggage, boxes, or other items of interest that are being carried into the venue by an individual 14. In one embodiment, one X-ray detection device 118 is located in only two screening lanes 80, being the two lanes 80 closest to the control room 78. The X-ray detection device 118 may be similar to the HI-SCAN 5030C or HI-SCAN 6040i commercially available from Smiths Detection, for example. The X-ray detection device 118 may be bolted in place within each screening lane 80. To this end, the X-ray detection device 118 is configured to continuously or intermittently transmit data to the processing unit 24.

Each screening lane 80 further includes a touchless ticket scanning device 120 capable of scanning ticketing, drivers' licenses, passports, or other identification means carried by an individual 14 for admittance into the venue. The ticket scanning device 120 may be a portable electronic device such as a tablet or cellphone that employs scanning technologies such as Quick Response (QR) code or barcode ticket verification to scan both electronic and paper tickets. As shown, the ticket scanning device 120 may be located on the sidewall 108 of each screening lane 80 or, alternatively, on a post located within each screening lane 80. The ticket scanning device 120 is capable of scanning tickets or other identification means from a distance so as to not impede the flow of individuals 14 through the screening lane 80. In one embodiment, the ticket scanning device 120 includes at least one digital camera, or digital video camera, that enables identity confirmation of an individual 14 using the identification module 38, and more particularly the facial recognition software, to confirm the identity of the individual 14. The scanning device 120 of this embodiment would record and transmit data in the form of biometrics (e.g., fingerprints, eye(s), and/or an individual's 14 face) to the identification module 38 for determination and confirmation of an individual's 14 identity. To this end, the ticket scanning device 120 is configured to continuously or intermittently transmit data to the processing unit 24. The data received by the processing unit 24 is analyzed using the identification module 38 to verify identification of the individual 14 for admittance to the venue.

The hub unit 16 may include various other screening devices 42 in combination with those described above, or as an alternative, such as an acoustic-based detection device that relies on microphones to detect sound waves created by bullets, as well as the muzzle blast generated by firing the bullets, explosions, or other nefarious sound sources. The hub unit 16 may also include a shoe scanning device which is a ground-based imaging platform that utilizes electromagnetic waves to generate an image of an individual's 14 shoe or shoes, which is evaluated to determine if an object may constitute a threat. Each screening lane 80 may further include various other aspects, such as one or more air fresheners, for example.

As shown in FIG. 9, and previously described, each of the lane screening devices 42, and more particularly, each pair of magnetic radar posts 112, each video camera 114, each biohazard detection device 116, the at least one X-ray imaging device 118, and each ticket scanning device 120 are operatively coupled to the processing unit 24. More particularly each lane screening device 42 is coupled to the processing unit 24 via ethernet cabling 180 which may be routed through the walls 62, 64, 66, 68, 70, 72 or other structure of the hub unit 16. In one embodiment, the cabling 180 for each screening device 42 may be routed to a secure network rack located in a corresponding screening lane 80 so as to consolidate the cabling 180. Each network rack may then be coupled to the processing unit 24.

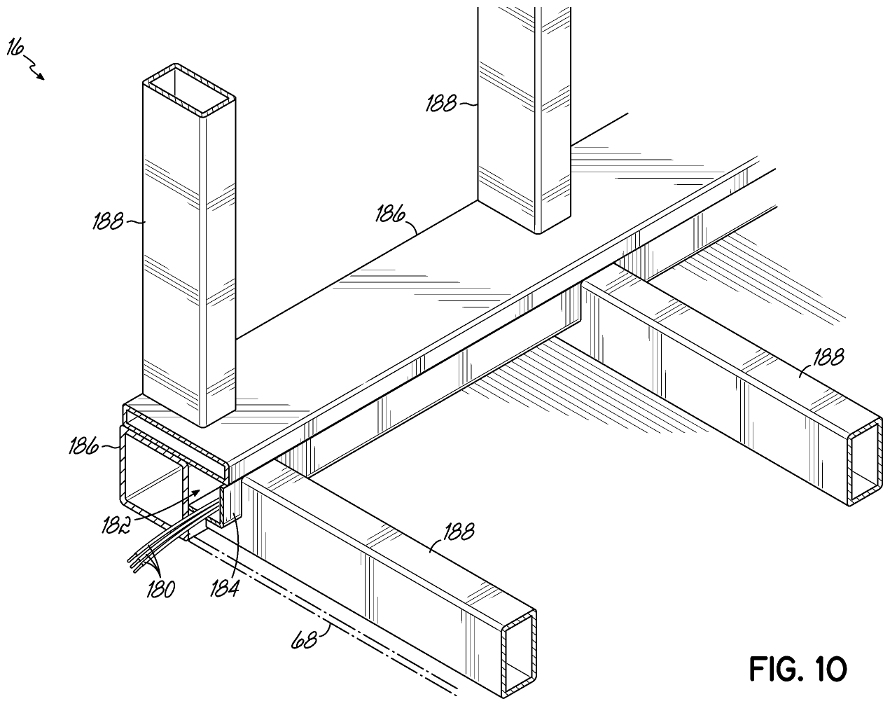

As shown in FIG. 10, to mitigate electrical interference between all the screening devices 42, 44, the hub unit 16 includes one or more discrete wireways 182 having a conduit 184 formed of a suitable conductive material, such as aluminum, steel, or copper, for example, to shield or minimize capacitively coupled noise, otherwise referred to as electromagnetic interference (EMI), from other electrical sources within the hub unit 16 and to thereby improve data transmission between the screening devices 42, 44 and the processing unit 24. The shielded wireways 182 effectively remove most, if not all, EMI. As shown, the exemplary wireway 182 may be located between one or more horizontal frame members 186 and one or more crossmembers 188 that form the bottom wall 68 of the hub unit 16, for example. Several of the crossmembers 188 may include a notch to accommodate for the wireway 182, as shown. However, it is possible to locate wireway 182 elsewhere, such as at the top wall 66, for example. The wireway 182 may extend an entire length, or a partial length, of the hub unit 16 between the first end wall 62 and the second end wall 64, for example.

As described above and with reference back to FIG. 1, the mobile security system 10 may further include one or more perimeter units 18 used to screen individuals 14 for security threats as they move within the unsecured area 28 and from the perimeter 22 of the venue to the point of entry 12 to the venue. In this regard, each perimeter unit 18 includes a base 190 that supports one or more lights 192 and at least one perimeter screening device 46. Each perimeter unit 18 may optionally include solar panels 194 configured to generate electricity to power components of the perimeter unit 18 such that the perimeter unit 18 is self-sufficient. In an alternative embodiment, each perimeter unit 18 may be powered by a generator, battery, or linear power supply, for example. The perimeter screening device 46 may include a wide-angle camera or video camera with infrared, thermal, electro-optical capabilities, and/or a speakerphone which may be used to communicate with the crowd for crowd management, for example. In one embodiment, the speakerphone may be used to screen conversations of individuals 14 which includes detecting the use of certain threat words such as “bomb,” “gun,” “ammo,” or “knife,” for example. Each perimeter unit 18 is connected to the processing unit 24 in a wired or wireless mode, such as via mmWave technology, for example. mmWave technology is the use of frequency bands in the 24 GHz to 300 GHz range, known as millimeter wave (mmWave), for wireless communication and transmission of data. To this end, each perimeter unit 18 is configured to continuously or intermittently transmit data from the one or more perimeter screening devices 46 to the processing unit 24. Each perimeter unit 18 may further include displays and/or signage for crowd management.

In addition to the perimeter units 18, or as an alternative, the security system 10 may further include one or more drones 20 configured to communicate (via an onboard speakerphone device) with and screen individuals 14 for security threats as they move within the unsecured area 28 and from the perimeter 22 of the venue to the point of entry 12 to the venue. Each drone 20 may be configured to fly in a preprogrammed flight pattern over the secure and/or unsecured areas 26, 28 to screen for security threats. In this regard, each drone 20 may have a drone screening device 48 such as a wide-angle camera or video camera with infrared, thermal, electro-optical, and/or speakerphone capabilities, for example. In one embodiment, the speakerphone may be used to issue communications to individuals 14 and/or screen conversations of individuals 14 which includes detecting the use of certain threat words such as “bomb,” “gun,” “ammo,” or “knife,” for example. The drones 20 may be connected to a perimeter unit 18 or the hub unit 16 in a wired (e.g., tethered) or wireless (e.g., via mmWave technology or WiFi) mode to transmit data to the processing unit 24. Each drone 20 may have a docking or charging station located on the hub unit 16, such as the top wall 66 of the hub unit 16, for example.

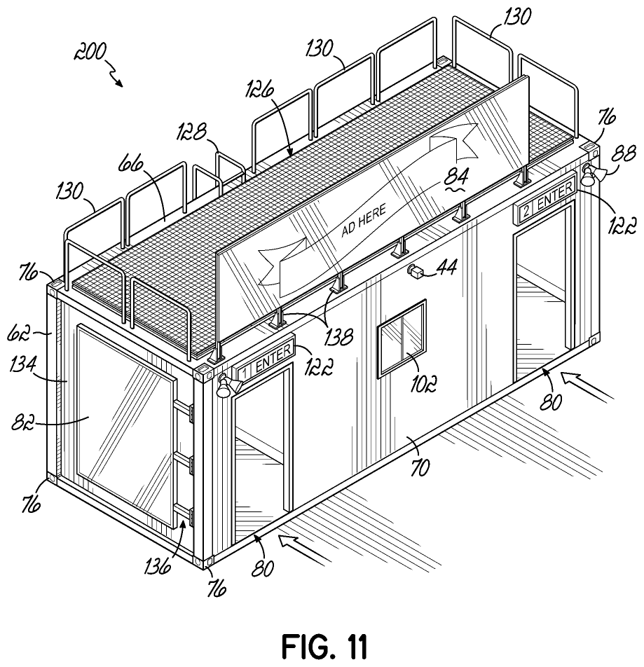

With reference to FIG. 11, wherein like numerals represent like features, details of an exemplary hub unit 200 are shown in accordance with another embodiment of the present invention. The primary differences between the hub unit 200 of this embodiment and the hub unit 16 of the previously described embodiment is that the hub unit 200 has a smaller overall footprint and includes only two screening lanes 80. Further, the hub unit 200 only includes one top display screen 84 and does not include a front display screen 86 over the front-facing window 102.

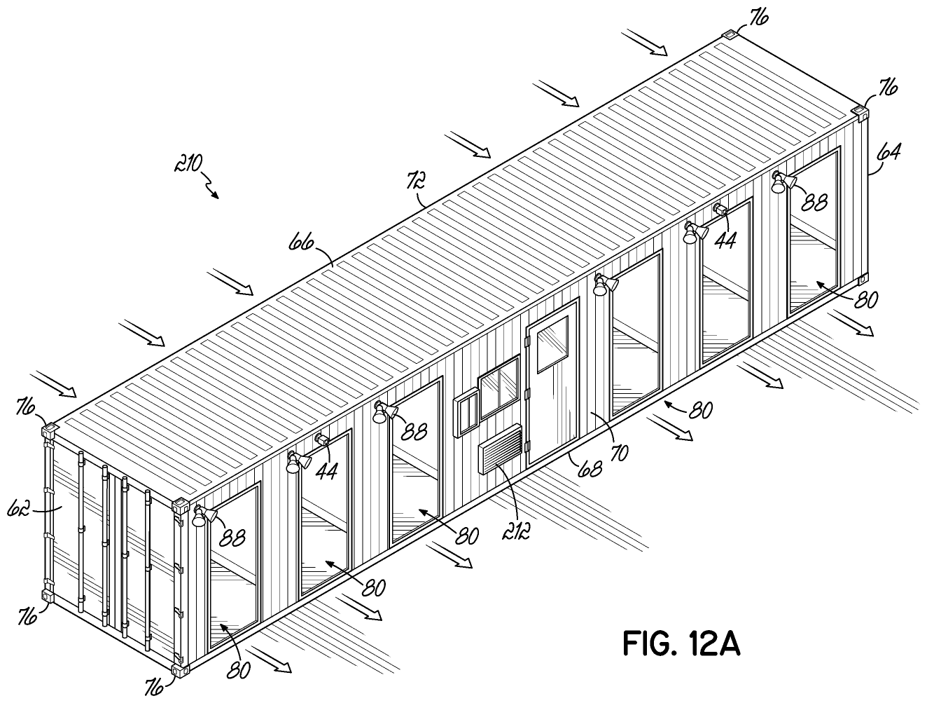

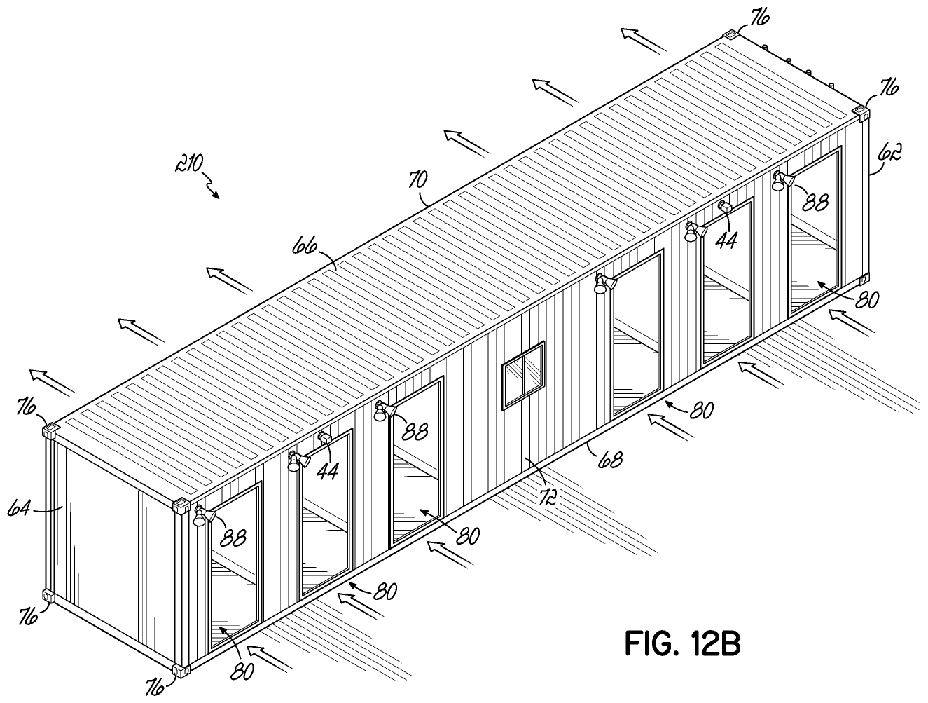

With reference to FIGS. 12A and 12B, wherein like numerals represent like features, details of an exemplary hub unit 210 are shown in accordance with another embodiment of the present invention. The primary differences between the hub unit 210 of this embodiment and the hub unit 16 of the above-described embodiment is that the hub unit 210 is formed from an Intermodal Shipping Container (ISO) and may have dimensions similar to those of a standard ISO shipping container. In this regard, the hub unit 210 may have six screening lanes 80 similar to the embodiment of the above-described hub unit 16. The hub unit 210 of this embodiment may include additional features such as a conditioned air means 212 configured to supply hot and/or cold air to the control room 78.

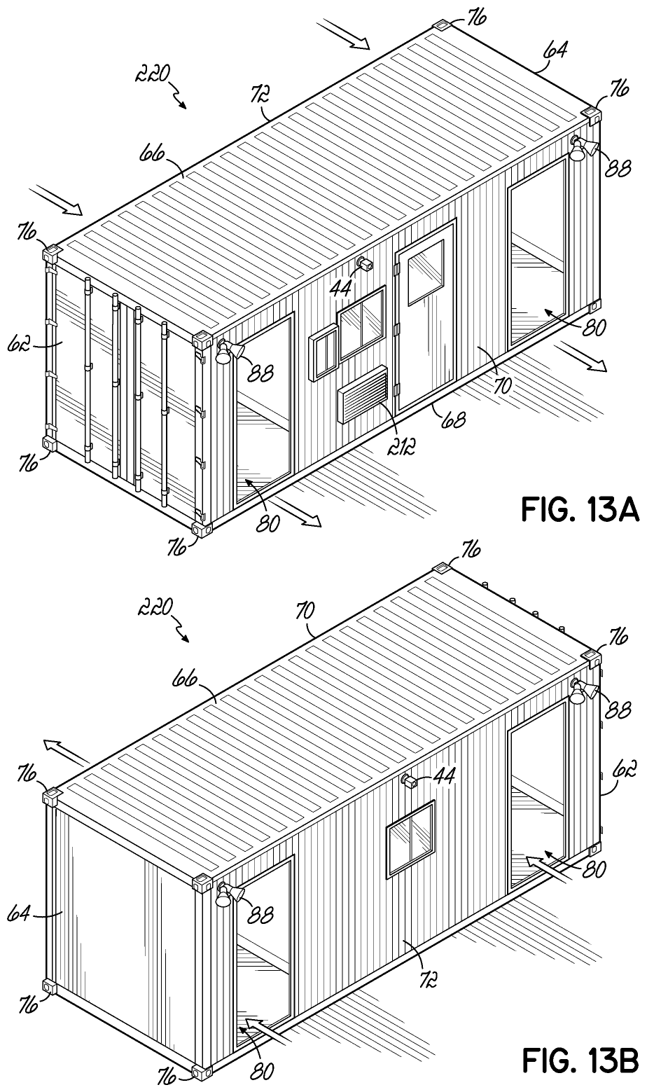

With reference to FIGS. 13A and 13B, wherein like numerals represent like features, details of an exemplary hub unit 220 are shown in accordance with another embodiment of the present invention. The primary differences between the hub unit 200 of this embodiment and the hub unit 210 of the previously described embodiment is that the hub unit 220 has a smaller overall footprint and includes only two screening lanes 80.

While the invention has been illustrated by the description of various embodiments thereof, and while the embodiments have been described in considerable detail, it is not intended to restrict or in any way limit the scope of the appended claims to such detail. Thus, the various features discussed herein may be used alone or in any combination. Additional advantages and modifications will readily appear to those skilled in the art. The invention in its broader aspects is therefore not limited to the specific details and illustrative examples shown and described. Accordingly, departures may be made from such details without departing from the scope of the general inventive concept.

What is claimed is:

1. A mobile security system for managing pedestrian activities from a perimeter of a venue to a point of entry to the venue as well as pedestrian entry into the venue, comprising:
a portable hub unit configured to be located at the venue and between an unsecured area outside the venue and a secured area inside the venue, the hub further comprising;
at least one touchless screening lane that defines a path through the hub unit from the unsecured area outside of the venue to the secured area inside the venue;
at least one external screening device located on the hub unit that screens for security threats external to the hub unit;
a plurality of lane screening devices associated with the at least one screening lane to screen for security threats within the at least one screening lane; and
a processing unit having one or more processors including program code that, when executed by the one or more processors, causes the one or more processors to:
receive data from the at least one external screening device and the plurality of lane screening devices;
characterize the received data as being indicative of one or more security threats or a non-security threat; and
in response to determining that the received data is indicative of one or more security threats, output a notification that identifies the one or more security threats.

2. The mobile security system of claim 1, wherein the hub unit further comprises a control room located within the hub unit and being an enclosed space separate from the at least one screening lane, the control room having an access door.

3. The mobile security system of claim 1, wherein the at least one external screening device monitors for security threats between the hub unit and the perimeter of the venue.

4. The mobile security system of claim 1, wherein each of the plurality of lane screening devices and the at least one external screening device screen for security threats in a touchless manner.

5. The mobile security system of claim 1, wherein the plurality of lane screening devices associated with the at least one screening lane include one or more of the following:
a video camera;
a thermal sensor;
a pair of magnetic radar posts;
a biohazard detection device;
a radiation detection device; or
an x-ray detection device.

6. (canceled)

7. The mobile security system of claim 1, wherein the data received from the plurality of lane screening devices and the at least one external screening device is characterized as being indicative of one or more of the following security threats:
(i) a concealed weapon threat;
(ii) an exposed weapon threat;
(iii) a bomb threat;
(iv) a biohazard threat;
(v) a radiation threat;
(vi) a personal protective equipment non-compliance threat;
(vii) an elevated body temperature threat; or
(viii) a crowd disturbance threat.

8. The mobile security system of claim 1, wherein the at least one screening lane further comprises a touchless ticket scanning device configured to scan a ticket to determine pedestrian admittance into the venue.

9. The mobile security system of claim 1, wherein the processing unit is programmed to send the notification to one or more computing devices in a network.

10. The mobile security system of claim 1, wherein the hub unit further comprises at least one illuminated display device pivotably coupled to one of either a first end wall, a second end wall, or a top wall of the hub unit.

11. The mobile security system of claim 10, wherein the at least one illuminated display device is movable between an extended position where the illuminated display device extends away from the one of either the first end wall, the second end wall, or top wall and a stowed position where the illuminated display device extends alongside the one of either the first end wall, the second end wall, or top wall.

12. The mobile security system of claim 11, wherein the first end wall includes a first illuminated display device and the second end wall includes a second illuminated display device.

13. (canceled)

14. (canceled)

15. The mobile security system of claim 1, wherein the hub unit further comprises one or more solar panels located on a top wall of the hub unit and being configured to generate electricity to power components of the hub unit.

16. The mobile security system of claim 15, wherein the one or more solar panels are configured to provide power via ethernet cabling to the at least one external screening device and the plurality of lane screening devices.

17. The mobile security system of claim 16, wherein the ethernet cabling is routed through shielded wireways.

18. The mobile security system of claim 1, wherein a front wall of the hub unit includes a display device located above an entrance to the at least one screening lane that is configured to display a screening status of the at least one screening lane.

19. The mobile security system of claim 1, wherein a back wall of the hub unit includes a display device located above an exit to the at least one screening lane that is configured to display a screening status of the at least one screening lane.

20. The mobile security system of claim 19, wherein the processing unit is programmed to operate each display device as follows:
if received data from one or more of the plurality of lane screening devices associated with the at least one screening lane is characterized as being indicative of one or more security threats, change the screening status of each display device to indicate a detected security condition.

21. The mobile security system of claim 1, further comprising at least one perimeter unit configured to be located a distance from the hub unit and within the unsecured area outside of the venue, the perimeter unit comprising:
at least one perimeter screening device to screen for security threats;
wherein the processing unit is further programmed to receive data from the at least one perimeter screening device.

22. A portable hub unit for managing pedestrian activities from a perimeter of a venue to a point of entry to the venue as well as pedestrian entry into the venue, comprising:
at least one screening lane that defines a path through the hub unit from an unsecured area outside of the venue to a secured area inside the venue;
at least one external screening device located on the hub unit that screens for security threats external to the hub unit;
a plurality of lane screening devices associated with the at least one screening lane that screen for security threats within the at least one screening lane; and
a processing unit having one or more processors including program code that, when executed by the one or more processors, causes the one or more processors to:
receive data from the at least one external screening device and the plurality of lane screening devices;
characterize the received data as being indicative of one or more security threats or a non-security condition; and
in response to determining that the received data is indicative of one or more security threats, output a notification that identifies the one or more security threats.

23. A method for managing pedestrian entry into a venue, comprising:
providing a portable hub unit having at least one screening lane that defines a path through the hub unit from an unsecured area outside of the venue to a secured area inside the venue, at least one external screening device located on the hub unit that screens for security threats external to the hub unit, a plurality of lane screening devices associated with the at least one screening lane that screen for security threats within the at least one screening lane, and a processing unit operatively coupled to the at least one external screening device and the plurality of lane screening devices;
locating the hub unit between the unsecured area outside the venue and the secured area inside the venue;
operating the processing unit of the hub unit by receiving data from the at least one external screening device and the plurality of lane screening devices;
characterizing the received data as being indicative of one or more security threats or a non-security condition; and
if the received data is indicative of one or more security threats, outputting a notification that identifies the one or more security threats.

24. (canceled)
